(19) United States
(12) Patent Application Publication
(10) Pub. No.: US 2019/0057252 A1
(43) Pub. Date: Feb. 21, 2019

(54) LIVING BODY SEARCH SYSTEM

(71) Applicant: PRODRONE CO., LTD., Nagoya-shi, Aichi (JP)

(72) Inventors: Kazuo ICHIHARA, Nagoya-shi (JP); Masakazu KONO, Nagoya-shi (JP)

(73) Assignee: PRODRONE CO., LTD., Nagoya-shi, Aichi (JP)

(21) Appl. No.: 16/080,907

(22) PCT Filed: Feb. 23, 2017
(86) PCT No.: PCT/JP2017/006844

§ 371 Date: Aug. 29, 2018

(30) Foreign Application Priority Data
Mar. 11, 2016 (JP) 2016-049026

(51) Int. Cl. G06K 9/00; B64C 39/02

(52) U.S. Cl. CPC G06K 9/00369; G06K 9/00288; B64C 39/024; B64C 2201/146; B64C 2201/127; B64C 2201/141; B64C 2201/123

(57) ABSTRACT

A living body search system includes an unmanned moving body and a server. The body includes: a camera; image data processing for retrieving image data; moving means; and communicating. The server includes: a database configured to record therein search data; and notifies a client. The body and the server are connected to each other through a communication network. The system includes individuals in the image data wherein individual identification information records the database to determine whether the candidate object in the image data is a searched-for object. The system registers, in the server, searched-for data provided in advance from the client. The system compares image data retrieved from the camera with the individual identification information to perform individual recognition. When the image data matches the individual identification information, the system determines that the object has been found. Then, the system notifies the client that the searched-for object has been found.

### TECHNICAL FIELD

The present invention relates to a living body search system for searching fora particular human being and/or the like within a predetermined range such as inside or outside a building.

### Technical Field

Conventionally, human search systems such as lost-child search systems have been proposed (see PTL 1).

A lost-child search system includes: an ID tag that is carried by a human being in a facility such as an amusement park and that upon receipt of an interrogation signal, transmits unique information of the ID tag registered in advance; an interrogator that is located at a predetermined place in the facility and that when the human being carrying the ID tag passes the interrogator, transmits the interrogation signal to the ID tag to request the unique information of the ID tag to be transmitted; a camera device that is located at a predetermined place in the facility and that when the human being carrying the ID tag passes the camera device, picks up an image of the human being; and a controller that prepares identification data of the human being by combining the image of the human being obtained at the camera device and the unique information of the ID tag obtained at the interrogator.

The lost-child search system performs a search by: picking up images of facility visitors using a camera; combining each of the obtained images with an ID and automatically recording the resulting combinations; when there is a lost child, checking a history of readings of the ID of the lost child at interrogators scattered around the facility so as to roughly identify the location of the lost child; and printing out the image of the lost child for a staff member to search the facility for the lost child.

Another known monitoring system includes a plurality of monitoring camera devices that cooperate with each other to capture a video of a moving object that is targeted for tracking (see PTL 2).

Each monitoring camera device of the monitoring system includes an image recognition function that transmits, through a network, an obtained video of the tracking target and characteristics information to other monitoring camera devices. This configuration allegedly enables the monitoring system to continuously track the tracking target.

### CITATION LIST

### Patent Literature

PTL1: JP H10-301984A

PTL2: JP 2003-324720A

### SUMMARY OF INVENTION

### Technical Problem

In the lost-child search system recited in PTL 1, the camera is fixed and thus unable to track a searched-for target.

With the monitoring system recited in PTL 2, although a monitoring target can be tracked by switching the plurality of cameras, since the position of each camera is fixed, blind spot problems are inevitable. Additionally, even though the monitoring target can be tracked using the cameras, if the monitoring target is far from the cameras, the monitoring target may be too small in the image to identify, leaving image recognition difficulty problems.

It is an object of the present invention to provide a living body search system that searches for a searched-for object quickly and accurately.

### Solution to Problem

In order to solve the above-described problem, the present invention provides a living body search system configured to, at a search request from a client, search for a living individual as a searched-for object within a predetermined range inside or outside a building. The living body search system includes an unmanned moving body and a server. The unmanned moving body includes: a camera configured to observe a space around the unmanned moving body; image data processing means for, when a predetermined characteristic portion of a candidate object has been detected in an observation image taken by the camera, retrieving image data of the observation image; moving means for freely moving in a space; and communicating means for transmitting and receiving data to and from the server. The server includes: a database configured to record therein search data that includes individual identification information of the searched-for object and notification destination information of the client; and notifying means for, when the searched-for object has been found, notifying the client that the searched-for object has been found. The unmanned moving body and the server are connected to each other through a communication network. The unmanned moving body or the server includes individual identifying means for comparing the image data with the individual identification information to determine whether the candidate object in the image data is the searched-for object. The living body search system includes: a data registering step of registering, in the server, searched-for data provided in advance from the client; a moving step of causing the moving body to move within a search range while causing the camera to observe the space around the moving body; an image data processing step of, when the predetermined characteristic portion has been detected in the observation image of the camera, determining that the searched-for object has been detected and retrieving the observation image of the camera as image data; an individual recognizing step of comparing the image data with the individual identification information of the searched-for object to perform individual recognition; and a notifying step of, when the searched-for object in the image data matches the individual identification information in the individual recognition, determining that the searched-for object has been found and causing the notifying means to notify the client that the searched-for object has been found.

In the living body search system, the unmanned moving body is preferably an unmanned aerial vehicle.

In the living body search system, the unmanned moving body preferably includes a plurality of unmanned moving bodies.

The living body search system is preferably a human search system configured to search for a human being as the searched-for object. The image data processing step preferably includes a face detecting step using a face of the human being as the predetermined characteristic portion. The individual recognizing step preferably uses, as the individual identification information, face information of the human being searched for.

In the living body search system, the image data processing step preferably includes a human detecting step of, when a silhouette of the human has been recognized in the observation image, determining that the human has been detected. When the human has been detected in the human detecting step and when the face of the human has not been detected in the face detecting step, the living body search system is preferably configured to control the moving body to move to a position at which the face is detectable.

In the living body search system, the search data associated with the client preferably includes tracking necessity information indicating whether it is necessary to track the searched-for object. When the tracking necessity information indicates that it is necessary to track the searched-for object, the living body search system preferably includes a tracking step of, upon finding of the searched-for object, causing the moving body to track the searched-for object.

In the living body search system, the search data associated with the client preferably includes a message from the client for the searched-for object. When the searched-for object has been found, the living body search system preferably includes a message giving step of giving the message to the searched-for object.

### Advantageous Effects of Invention

The living body search system according to the present invention searches for a living body using an unmanned moving body. The unmanned moving body includes: a camera that observes a space around the unmanned moving body; an image recording means; moving means for freely moving in a space; and communicating means for transmitting and receiving data to and from a server. With this configuration, the camera is movable to any desired position and thus capable of tracking a searched-for object without blind spot occurrences. This configuration also eliminates or minimizes such an occurrence that a searched-for object is far away from the camera, facilitating image recognition. As a result, such an advantageous effect is obtained that a searched-for object is searched for quickly and accurately.

### BRIEF DESCRIPTION OF DRAWINGS

FIG. 1 illustrates a schematic configuration of the living body search system according to one embodiment of the present invention.

FIG. 2 is a block diagram illustrating a configuration of an unmanned aerial vehicle of the living body search system illustrated in FIG. 1.

FIG. 3 is a flowchart of a procedure for a search performed by the living body search system illustrated in FIG. 1.

### DESCRIPTION OF EMBODIMENTS

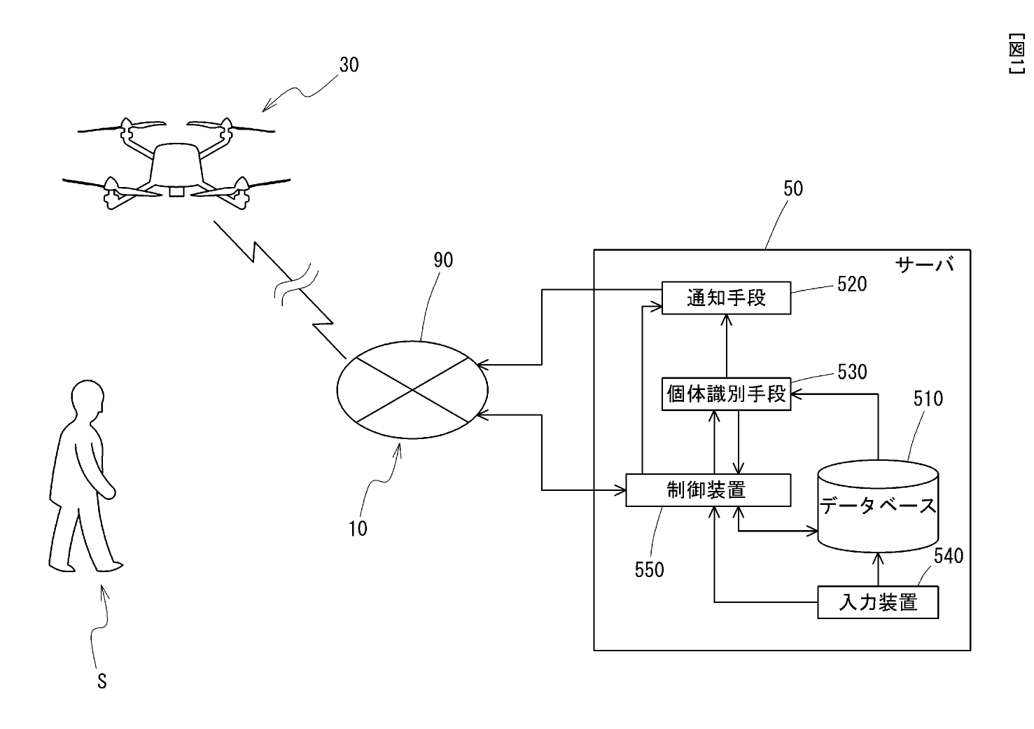

The living body search system according to the present invention will be described in detail below by referring to the drawings. FIG. 1 illustrates a schematic configuration of the living body search system according to one embodiment of the present invention. The embodiment illustrated in FIG. 1 is a human search system that searches for a particular human being S (searched-for person) as a searched-for object, and that uses an unmanned aerial vehicle (multicopter 30) as an unmanned moving body.

The human search system illustrated in FIG. 1 searches for, within a predetermined range inside or outside a building, a particular human individual (living individual) as a searched-for object at a request from a client. The human search system 10 includes the multicopter 30 and a server 50. The unmanned aerial vehicle 30 and the server 50 are connected to each other through a communication network 90 so that data can be transmitted and received between the unmanned aerial vehicle 30 and the server 50. The server 50 is located in, for example, a search center and undergoes operations, such as a data input operation, from a staff member.

The communication network 90 may be either a shared network used for convenience of the public or a unique network. The communication network 90 and the wireless airplane 30 are connected to each other wirelessly. The communication network 90 and the server 50 may be connected to each other in a wireless or wired manner. Examples of the shared network include a typical fixed line, which is wired, and a mobile phone line.

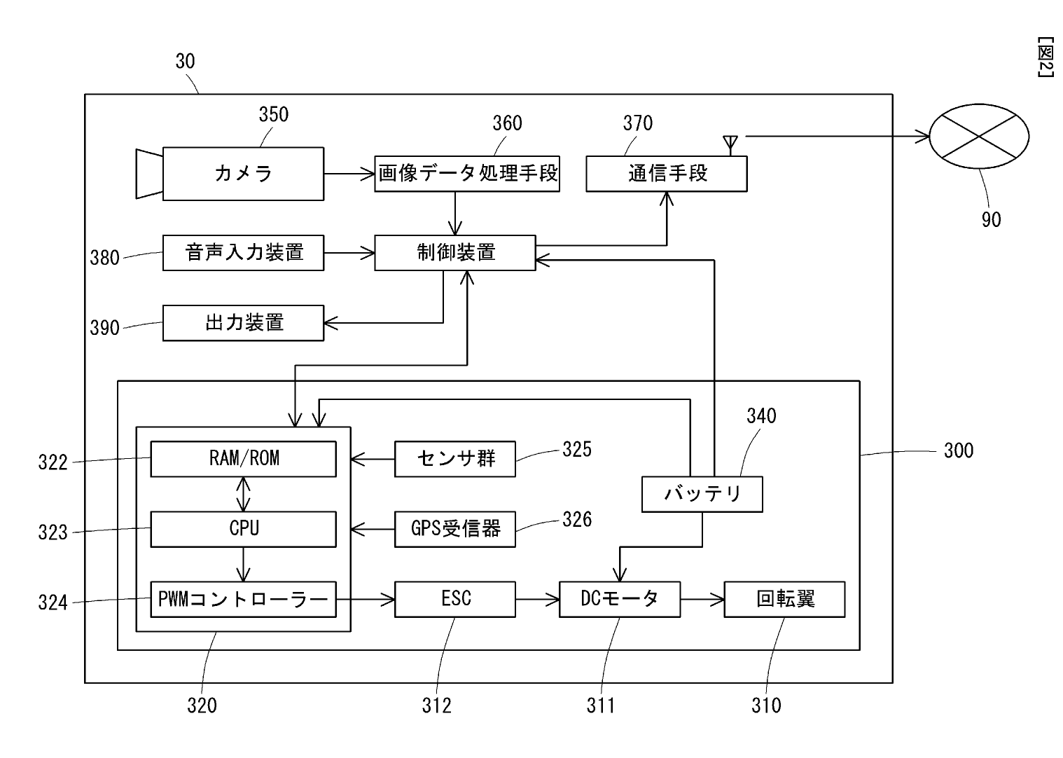

FIG. 2 is a block diagram illustrating a configuration of the unmanned moving body of the living body search system illustrated in FIG. 1. In the human search system illustrated in FIG. 1, the multicopter 30 is an unmanned moving body. As illustrated in FIG. 2, the multicopter 30 includes moving means 300, which is capable of flying to move anywhere in the space. The moving means 300 of the multicopter 30 includes elements such as: a plurality of propellers 310, which generate lift force; a controller 320, which controls operations such as a flight operation; and a battery 340, which supplies power to the elements of the moving means 300. The multicopter 30 is formed to make an autonomous movement.

In the present invention, the unmanned moving body may be other than an unmanned aerial vehicle. Another possible example is an unmanned automobile, which is capable of making automatic driving. It is to be noted that using an unmanned aerial vehicle such as a multicopter eliminates the need for wading through a crowd of people. Also, since an unmanned aerial vehicle flies at a height beyond the reach of human beings, the possibility of being mischievously manipulated is minimized.

While the above-described multicopter is autonomously movable, the unmanned moving body may be movable by remote control.

Each propeller 310 is connected with a DC motor 311, which is connected to the controller 320 through an ESC (Electric Speed Controller) 312. The controller 320 includes elements such as a CPU (Central Processing Unit) 323, an RAM/ROM (storage device) 322, and a PWM controller 324. Further, the controller 320 is connected with elements such as: a sensor group 325, which includes an acceleration sensor, a gyro sensor (angular velocity sensor), a pneumatic sensor, and a geomagnetic sensor (electronic compass); and a GPS receiver 326.

The multicopter 30 is controlled by the PWM controller 324 of the moving means 300. Specifically, the PWM controller 324 adjusts the rotation speed of the DC motor 311 through the ESC 312. That is, by adjusting the balance between the rotation direction and the rotation speed of the plurality of propellers 310 in a desired manner, the posture and the position of the multicopter 30 are controlled.

For example, the RAM/ROM 322 of the controller 320 stores a flight control program in which a flight control algorithm for a flight of the multicopter 30 is described. The controller 320 uses information obtained from elements such as the sensor group 325 to control the posture and the position of the multicopter 30 based on the flight control program. Thus, the multicopter 30 is enabled by the moving means 300 to make a flight within a predetermined range to search for a searched-for object.

The multicopter 30 includes: a camera 350, which observes a space around the multicopter 30; image data processing means 360, which retrieves still-picture image data from the camera; and communicating means 370, which transmits, to the server 50, the image data retrieved at the image data processing means 360 and which receives data from the server 50. As the communicating means 370, a communication device capable of wireless transmission and reception is used.

The camera 350 may be any device that can be used to monitor and observe a space around the multicopter 30 and that is capable of picking up a still picture as necessary. Examples of the camera 350 include: a visible spectrum light camera, which forms an image using visible spectrum light; and an infrared light camera, which forms an image using infrared light. An image pick-up device such as one used in a monitoring camera may be used in the camera 350.

The multicopter 30 may include a plurality of cameras 350. For example, the multicopter 30 may include four cameras 350 pointed in four different directions. For further example, the camera 350 may be a 360-degree camera mounted on the bottom of the multicopter to observe the space around the multicopter omni-directionally.

The multicopter 30 includes the image data processing means 360, which regards a face of a human being as a characteristic portion of a candidate object. When a face of a human being is detected in an observation image taken by the camera 350, the image data processing means 360 retrieves still-picture data of the observation image.

The image data processing means 360 may be any means capable of retrieving image data into the moving body and the server. Specifically, examples of image data retrieval include: processing of recording image data in a recording device or a similar device; processing of temporarily storing image data in a storage device; and processing of transmitting image data to the server.

The image data processing means 360 uses face detecting means for detecting a face of a human being (hereinafter occasionally referred to as face detection). The face detecting means performs real-time image processing of an image that is being monitored to perform pattern analysis and pattern identification of the image. When, as a result, a face of a human being has been identified, the face detecting means determines that a face has been detected.

The image data processing means 360 also includes human detecting means. When a silhouette of a human being has been identified in an image that is being observed, the human detecting means determines that a human being has been detected. The human detecting means, similarly to face detection, performs image processing of the image to perform pattern analysis and pattern recognition of the image. When, as a result, a silhouette of a human being is identified in the image, the human detecting means determines that a human being has been detected.

In the image processing according to the present invention, the term face detection is to detect a position corresponding to a face, and the term face recognition refers to processing of, with a face already detected, identifying a human individual based on characteristics information of the face.

The multicopter 30 includes: a sound input device 380, such as a microphone; and an output device 390, which outputs sound, images, and videos, and/or the like. Upon finding of a searched-for person, the sound input device 380 may receive sound of the searched-for person so that the searched-for person can talk to, for example, a staff member at the search center. Examples of the output device 390 include: a sound output device, such as a speaker; an image display device, such as a liquid crystal display; and an image projection device, such as a projector. The output device 390 is used to give (transmit) a message to the searched-for person and is used by a staff member at the search center to talk to the searched-for person.

The server 50 includes elements such as: a database 510, which is capable of recording therein search data such as individual identification information of a searched-for person S and notification destination information such as a client's telephone number and mail address; notifying means 520 for, when the searched-for person S has been found, notifying the client that the searched-for person S has been found; individual identifying means 530 for comparing image data including an image of a candidate object input from the camera with the individual identification information recorded in the database 510 to determine whether the candidate object is the searched-for person; and an input device 540, which is used to input the search data into the database 510. The communication network 90 and the server 50. Performed through a controller.

The search data registered in the database 510 includes additional information, in addition to search range, individual identification information of the searched-for person, and notification destination information of the client. Examples of the additional information include data indicating whether tracking is necessary, and a sound message and/or a video message from the client for the searched-for person.

Examples of the individual identification information of the searched-for person registered in the database 510 include: image data such as a picture of a face of a human individual; information such as a color of clothing that a human individual wears; and data of a human individual such as height and weight.

The notifying means 520 is a communication instrument capable of communicating sound, letters, and images. Specifically, examples of the notifying means 520 include a mobile phone, a personal computer, and a facsimile. Examples of the notification destination to which the notifying means 520 makes a notification include a mobile phone, a control center, and the Internet or another network. When the searched-for object S has been found by the individual identifying means 530, a controller 550 searches the database 510 for the notification destination, and the notifying means 520 notifies the notification destination that the searched-for object S has been found. The notification may be in the form of sound, letters, image data, or a combination of the foregoing.

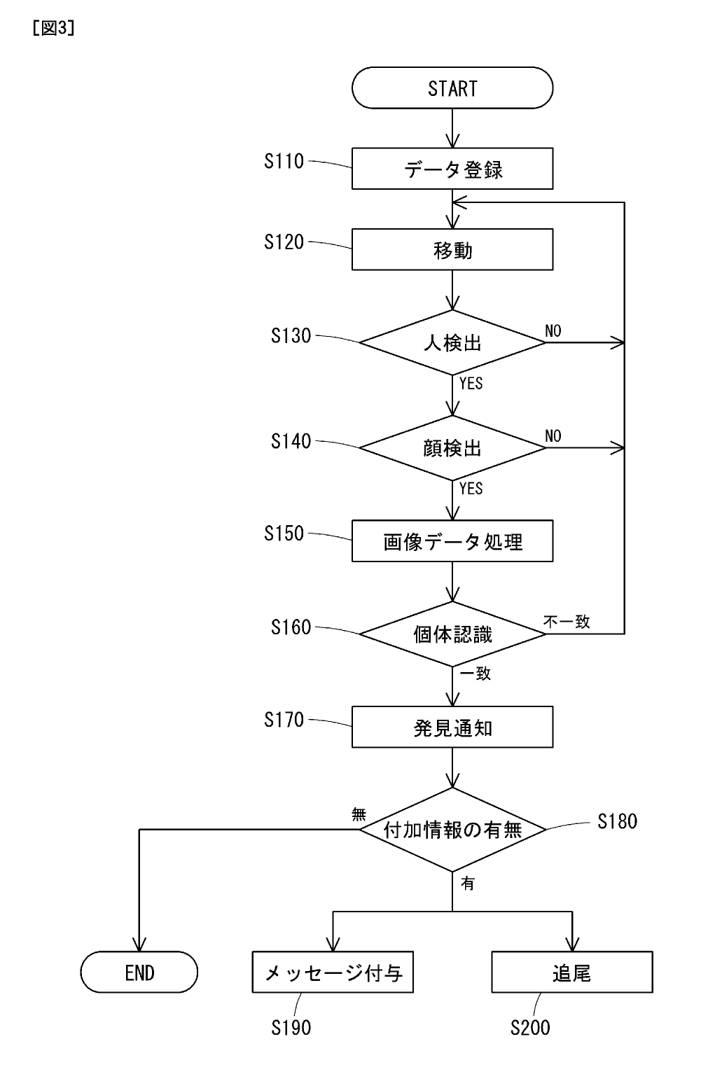

A procedure for a search performed by the human search system illustrated in FIG. 1 will be described below. FIG. 3 is a flowchart of a procedure performed by the human search system. The search procedure may follow the following example step.
S110: Data registering step of registering searched-for data provided in advance from the client.
S120: Moving step of causing the moving body to move within a search range while causing the camera to observe the space around the moving body.
S130: Human detecting step of detecting a human being by determining whether a human being is included in the observation image of the camera.
S140: Face detecting step of detecting a face by determining whether a face is included in the observation image of the camera.
S150: Image data processing step of, when a predetermined characteristic portion has been detected in the observation image of the camera, determining that a target candidate object has been detected and retrieving the observation image of the camera as image data.
S160: Individual recognizing step of comparing the target candidate object in the image data with the individual identification information of the searched-for object to perform individual recognition of the target candidate object.
S170: Finding notifying step of, when the target candidate object in the image data matches the individual identification information in the individual recognizing step, determining that the searched-for object has been found and causing the notifying means to notify the client that the searched-for object has been found. These steps will be described below.

As illustrated in FIG. 3, first, in the data registering step at S210, an operator at the search center uses the input device 540 of the server 50 to register search data provided from the client in the database 510.

Next, in the moving step at S120, the controller 550 of the server 50 transmits a control signal to the multicopter 30 through the communication network 90, causing the multicopter 30 to move within a predetermined search range with the camera 350 observing the space around the multicopter 30.

Next, in the human detecting step at S130, human detection is performed by making a determination as to whether a human being is included in the observation image of the camera 350. When no human being is detected in the human detecting step at S130 (NO), the procedure returns to the moving step at S120, at which the multicopter 30 moves further within the search range. When a human being has been detected in the human detecting step at S120 (YES), the procedure proceeds to the next face detecting step at S140. In the human detecting step at S120, a human being is determined as detected when a silhouette of a human being has been recognized.

In the face detecting step at S140, a determination is made as to whether an image of a face is included in the observation image of the camera. When there is no image of a face (NO), the procedure returns to the moving step at S120, causing the multicopter 30 to move. To facilitate face detection, the multicopter 30 is caused to move to a position, for example, in front of a face of a human being. In contrast, when an image of a face has been detected (YES), a determination is made that a candidate has been detected, and the procedure proceeds to the image data processing step at S150.

In the image data processing step at S150, the image data processing means 360 stores, as image data, the image taken by the camera 350. The stored image data is transmitted by a controller 392 to the server 50 through the communication network 90 using the communicating means 370.

Next, the server 50 performs the individual recognizing step at S160. In the individual recognizing step at S160, the image data transmitted to the server 50 is transmitted to the individual identifying means 530 through the controller 550. Then, a determination is made as to whether the human being (candidate) in the face information image data is the searched-for person based on face information of the searched-for person registered as human individual identification information in the database. The determination is made by comparing the face image data with a single piece or a plurality of pieces of face information registered. In excess of a predetermined matching ratio, the comparison is determined as matching, and the procedure proceeds to the next finding notifying step at S170. In contrast, when the result of the comparison falls short of the predetermined matching ratio, the comparison is determined as mis-matching, and the procedure returns to the moving step at S120, causing the multicopter 30 to move.

In the finding notifying step at S170, the notifying means 520 notifies the client that the searched-for person S has been found. The notification, indicating the fact of finding, is made to the notification destination registered in advance (such as a mobile phone, the control center, and the Internet).

In the finding notifying step at S170, the notification may additionally include position information regarding the position of finding. In the case of an outdoor position, the position information may be position information of a GPS receiver of the multicopter 30. In the case of an indoor position, the position information may be a video of the space around the position of finding, or may be position information used by the multicopter to estimate the position of the multicopter itself.

Next, an inquiry is made to the database 510 as to whether the search data includes additional information. When there is no additional information, the processing ends. When there is additional information, the processings in the message giving step at S190 and the tracking step at S200 follow.

In the message giving step at S190, the output device of the multicopter 30 transmits, to the searched-for person S, the client's sound message, video message, or another form of message registered in advance in the database. It is also possible for a staff member at the control center, which is on the server 50 side, to communicate with the searched-for person S by making voice communication, image-added voice communication, or another form of communication using: the camera 350; the sound input device 380, an example of which is a microphone; and the output device 390, which outputs images, sound, and another form of information.

In the tracking step at S200, when there is a person in the search data in the database who is identified with a flag indicating a necessity of tracking, the flight of the multicopter 30 is controlled to cause the multicopter 30 to go on tracking the searched-for person S, thus continuing monitoring of the searched-for person S.

In the tracking step at S200, the monitoring is implemented by tracking. In this case, one multicopter 30 is unable to search the entire predetermined search range at the same time. In light of the circumstances, it is possible to prepare an extra multicopter and cause the extra multicopter to go into action at the start of tracking and take over the search in the predetermined range.

Also in the tracking step at S200, it is also possible to cause another multicopter to go into action to perform tracking. In this case, two separate multicopters are provided, one multicopter being dedicated to general monitoring and the other multicopter being dedicated to tracking monitoring. Thus, each multicopter specializes in a unique function. For example, the multicopter dedicated to general monitoring may be large in size and serve a long period of time; specifically, the multicopter may be equipped with a 360-degree camera at a lower portion of the structure of the multicopter or equipped with four cameras pointed in four different directions and capable of performing photographing processing simultaneously. In contrast, the multicopter dedicated to tracking monitoring may be a smaller device that is equipped with a single camera and that makes a low level of noise.

When both the multicopter dedicated to general monitoring and the multicopter dedicated to tracking monitoring are used, if the multicopter dedicated to tracking monitoring is sufficiently small in size, the multicopter dedicated to tracking monitoring may be incorporated in the multicopter dedicated to general monitoring and configured to go into action to perform tracking.

Now that the embodiment of the present invention has been described hereinbefore, the present invention will not be limited to the above embodiment but is open for various modifications without departing from the scope of the present invention.

In the present invention, the living individual exemplified above as a searched-for object will not be limited to a human being; the present invention is also applicable to any other kinds of living individuals, examples including: pets such as a dog and a cat; and other animals.

Also in the above-described embodiment, an image picked up by the camera is transmitted as image data to the server, and the individual recognizing step is performed by the individual identifying means provided in an image server. If the performance of the CPU or the like of the multicopter is high enough to perform face recognition, it is possible to provide the individual identifying means in the multicopter so that the individual identifying means only receives face data of the searched-for object from the server and performs the individual recognizing step only in the multicopter.

It should be noted, however, that arithmetic processing involved in face recognition necessitates a high-performance CPU and a large database, whereas arithmetic processing involved in face detection, human detection, and a similar kind of detection necessitates less of performance than the arithmetic processing involved in face recognition. For cost and other considerations, it is not practical to provide the multicopter or the like with a high-performance CPU. As described in the above embodiment, it is more practical to transmit image data to the server through a communication network and cause the server to perform face recognition.

Also in the above-described embodiment, a visible spectrum light camera is used for individual recognition, and a searched-for person is detected by a face recognition technique using face information of image data obtained from the camera. As the individual identification information, a color or a pattern of clothing may be used. When the camera used is an infrared light camera, it is possible to detect the temperature of a searched-for object from a heat distribution image obtained by the infrared light camera and to perform individual identification using temperature data such as body temperature data as living individual identification information.

Together with face detection, it is possible to perform detection using data other than face data, in order to improve the accuracy of individual recognition. Examples of the other data include: information regarding size, such as the weight and height of a searched-for object; and a color of clothing. These pieces of data are effective when, for example, a face is not pointed at the camera of the multicopter.

1. A living body search system configured to search for a living individual as a searched-for object, the living body search system comprising:
an unmanned moving body; and
a server connected to the unmanned moving body through a communication network, wherein the unmanned moving body comprises
a camera configured to observe a space around the unmanned moving body,
a moving means for moving in a space or on a ground, and
image data processing means for, when a predetermined characteristic portion of the living individual has been detected in an observation image taken by the camera, retrieving image data of the observation image, and
wherein the server comprises
a database configured to record therein individual identification information of the searched-for object, and
individual identifying means for comparing the image data with the individual identification information to determine whether the living individual in the image data is the searched-for object.

2. A living body search system configured to search for a living individual person as a searched-for object, the living body search system comprising:
an unmanned moving body comprising:
a camera configured to observe a space around the unmanned moving body;
moving means for moving in a space or on a ground; and
image data processing means for, when a face of the person has been detected in an observation image taken by the camera, retrieving image data of the observation image,
wherein when the person has been detected in the observation image taken by the camera, the unmanned moving body is configured to automatically move to a position at which the face of the person is detectable.

3. The living body search system according to claim 2, further comprising a server connected to the unmanned moving body through a communication network, the server comprising:
a database configured to record therein, as individual identification information of the searched-for object, face information of the searched-for object; and
individual identifying means for comparing the image data with the face information to determine whether the person in the image data is the searched-for object.

4. The living body search system according to claim 1, wherein the unmanned moving body comprises an unmanned aerial vehicle.

5. The living body search system according to claim 1, wherein the unmanned moving body comprises a plurality of unmanned moving bodies.

6. The living body search system according to claim 1,
wherein when the server has determined that the living individual in the image data is the searched-for object, the unmanned moving body is configured to track the living individual.

7. The living body search system according to claim 1,
wherein when the server has determined that the living individual in the image data is the searched-for object, the unmanned moving body is configured to transmit a message recorded in advance to the living individual.

8. The living body search system according to claim 2, wherein the unmanned moving body comprises an unmanned aerial vehicle.

9. The living body search system according to claim 2, wherein the unmanned moving body comprises a plurality of unmanned moving bodies.

10. The living body search system according to claim 3,
wherein when the server has determined that the living individual in the image data is the searched-for object, the unmanned moving body is configured to track the living individual.

11. The living body search system according to claim 3,
wherein when the server has determined that the living individual in the image data is the searched-for object, the unmanned moving body is configured to transmit a message recorded in advance to the living individual.
